(19) United States
(12) Patent Application Publication
(10) Pub. No.: US 2015/0124059 A1
(43) Pub. Date: May 7, 2015

(54) MULTI-FRAME IMAGE CALIBRATOR

(71) Applicant: Nokia Corporation, Espoo (FI)

(72) Inventors: Mihail Georgiev, Tampere (FI); Atanas Gotchev, Pirkkala (FI); Miska Hannuksela, Tampere (FI)

(21) Appl. No.: 14/405,782

(22) PCT Filed: Jun. 8, 2012
(86) PCT No.: PCT/IB2012/052906

§ 371 Date: Dec. 4, 2014

(51) Int. Cl. G06T 7/00; H04N 13/02

(52) U.S. Cl. CPC G06T 7/002; H04N 13/0239; H04N 13/0246; G06T 2207/10012
USPC 348/47

(57) ABSTRACT

An apparatus comprising: an image analyser configured to analyse at least two images to determine at least one matched feature; a camera definer configured to determine at least two difference parameters between the at least two images; and a rectification determiner configured to determine values for the at least two difference parameters in an error search using an error criterion based on the at least one matched feature in the at least two images and an estimated difference parameter value, wherein the value for each difference parameter is determined serially.

### FIELD

The present application relates to apparatus for calibrating of devices for capture of video image signals and processing of those signals. The application further relates to, but is not limited to, portable or mobile apparatus for processing captured video sequences and calibrating multi-frame capture devices.

### BACKGROUND

Video recording on electronic apparatus is now common. Devices ranging from professional video capture equipment, consumer grade camcorders and digital cameras to mobile phones and even simple devices as webcams can be used for electronic acquisition of motion pictures, in other words recording video data. As recording video has become a standard feature on many mobile devices the technical quality of such equipment and the video they capture has rapidly improved. Recording personal experiences using a mobile device is quickly becoming an increasingly important use for mobile devices such as mobile phones and other user equipment.

Furthermore, three dimensional (3D) or stereoscopic camera equipment is commonly found on consumer grade camcorders and digital cameras. The 3D or stereoscopic camera equipment can be used in a range of stereo and multi-frame camera capturing applications. These applications include stereo matching, depth from stereo estimation, augmented reality, 3D scene reconstruction, and virtual view synthesis. However, effective stereoscopic or 3D scene reconstruction from such equipment require camera calibration and rectification as pre-processing steps.

Stereo calibration refers to the way of finding relative orientations of cameras in a stereo camera set up, while rectification refers to a way of finding projective transformations, which incorporate correction of optical system distortions and transform the captured stereo images of the scene to row-to-row scene correspondences. Rectification may be defined as a transform for projecting two or more images onto the same image plane.

Rectification simplifies the subsequent search for stereo correspondences which is then done in horizontal directions only. Approaches to find fast and robust camera calibration and rectification have been an active area of research for some time.

Furthermore image alignment may be required in multi-frame applications such as high dynamic range (HDR) imaging, motion compensation, super resolution, and image denoising/enhancement.

Multi-frame applications may differ from stereoscopic applications in that a single camera sensor takes two or more frames consecutively, where a stereoscopic or multi-frame camera sensor takes two or more frames simultaneously. In image alignment the two or more images are geometrically transformed or warped so that they represent the same view point. The aligned images can then be further processed by multi-frame algorithms such as super-resolution, image de-noising/enhancement, HDR imaging, motion compensation, data registration, stereo matching, depth from stereo estimation, 3D scene construction and virtual view synthesis.

### SUMMARY

Aspects of this application thus provide flexible audio signal focussing in recording acoustic signals.

According to a first aspect there is provided a method comprising: analysing at least two images to determine at least one matched feature; determining at least two difference parameters between the at least two images; and determining values for the at least two difference parameters in an error search using an error criterion based on the at least one matched feature in the at least two images and an estimated difference parameter value, wherein the value for each difference parameter is determined serially.

Determining values for the at least two difference parameters in an error search may comprise determining values for the at least two parameters to minimise the error search.

Analysing at least two images to determine at least one matched feature may comprise: determining at least one feature from a first image of the at least two images; determining at least one feature from a second image of the at least two images; and matching at least one feature from the first image and at least one feature from the second image to determine the at least one matched feature.

Analysing at least two images to determine at least one matched feature may further comprise filtering the at least one matched feature.

Filtering the at least one matched feature may comprise at least one of: removing matched features occurring within a threshold distance of the image boundary; removing repeated matched features; removing distant matched features; removing intersecting matched features; removing non-consistent matched features; and selecting a sub-set of the matches according to a determined matching criteria.

Determining at least two difference parameters between at least two images may comprise: determining from the at least two images a reference image; defining for an image other than the reference image at least two difference parameters, wherein the at least two difference parameters are stereo setup misalignments.

Determining at least two difference parameters between at least two images may comprise: defining a range of values within which the difference parameter value can be determined in the error search; and defining an initial value for the difference parameter value determination in the error search.

Determining values for the difference parameters in the error search may comprise: selecting a difference parameter, wherein the difference parameter has an associated defined initial value and value range; generating a camera rectification dependent on the initial value of the difference parameter; generating a value of the error criterion dependent on the camera rectification and at least one matched feature; repeating selecting a further difference parameter value, generating a camera rectification and generating a value of the error criterion until a smallest value of the error criterion is found for the difference parameter; and repeating selecting a further difference parameter until all of the at least two difference parameters have determined values for the difference parameters which minimise the error search.

The method may further comprise: generating a first image of the at least two images with a first camera; and generating a second image of the at least two images with a second camera.

The method may further comprise: generating a first image of the at least two images with a first camera at a first position; and generating a second image of the at least two images with the first camera at a second position displaced from the first position.

An apparatus may be configured to perform the method as described herein.

There is provided according to the application an apparatus comprising at least one processor and at least one memory including computer code for one or more programs, the at least one memory and the computer code configured to with the at least one processor cause the apparatus to at least perform: analysing at least two images to determine at least one matched feature; determining at least two difference parameters between the at least two images; and determining values for the at least two difference parameters in an error search using an error criterion based on the at least one matched feature in the at least two images and an estimated difference parameter value, wherein the value for each difference parameter is determined serially.

Determining values for the at least two difference parameters in an error search may causes the apparatus to perform determining values for the at least two parameters to minimise the error search.

Analysing at least two images to determine at least one matched feature may cause the apparatus to perform: determining at least one feature from a first image of the at least two images; determining at least one feature from a second image of the at least two images; and matching at least one feature from the first image and at least one feature from the second image to determine the at least one matched feature.

Analysing the at least two images to determine at least one matched feature further causes the apparatus to perform filtering the at least one matched feature.

The filtering the at least one matched feature may cause the apparatus to perform removing at least one of: removing matched features occurring within a threshold distance of the image boundary; removing repeated matched features; removing distant matched features; removing intersecting matched features; removing non-consistent matched features; and selecting a sub-set of the matches according to a determined matching criteria.

Determining at least two difference parameters between at least two images may cause the apparatus to perform: determining from the at least two images a reference image; and defining for an image other than the reference image at least two difference parameters, wherein the at least two difference parameters are stereo setup misalignments.

Determining at least two difference parameters between at least two images may cause the apparatus to perform: defining a range of values within which the difference parameter value can be determined in the error search; and defining an initial value for the difference parameter value determination in the error search.

Determining values for the difference parameters in the error search may cause the apparatus to perform: selecting a difference parameter, wherein the difference parameter has an associated defined initial value and value range; generating a camera rectification dependent on the initial value of the difference parameter; generating a value of the error criterion dependent on the camera rectification and at least one matched feature; repeating selecting a further difference parameter value, generating a camera rectification and generating a value of the error criterion until a smallest value of the error criterion is found for the difference parameter; and repeating selecting a further difference parameter until all of the at least two difference parameters have determined values for the difference parameters which minimise the error search.

The apparatus may further be caused to perform: generating a first image of the at least two images with a first camera; and generating a second image of the at least two images with a second camera.

The apparatus may further be caused to perform: generating a first image of the at least two images with a first camera at a first position; and generating a second image of the at least two images with the first camera at a second position displaced from the first position.

According to a third aspect of the application there is provided an apparatus comprising: an image analyser configured to analyse at least two images to determine at least one matched feature; a camera definer configured to determine at least two difference parameters between the at least two images; and a rectification determiner configured to determine values for the at least two difference parameters in an error search using an error criterion based on the at least one matched feature in the at least two images and an estimated difference parameter value, wherein the value for each difference parameter is determined serially.

The rectification determiner may comprise a rectification optimizer configured to determine values for the at least two parameters to minimise the error search.

The image analyser may comprise: a feature determiner configured to determine at least one feature from a first image of the at least two images and determine at least one feature from a second image of the at least two images; and a feature matcher configured to match at least one feature from the first image and at least one feature from the second image to determine the at least one matched feature.

The image analyser may further comprise a matching filter configured to filter the at least one matched feature.

The matching filter may comprise at least one of: a boundary filter configured to remove matched features occurring within a threshold distance of the image boundary; a repeating filter configured to remove repeated matched features; a far filter configured to remove distant matched features; an intersection filter configured to remove intersecting matched features; a consistency filter configured to remove non-consistent matched features; and criteria filter configured to select a sub-set of the matches according to a determined matching criteria.

The apparatus may further comprise: a camera reference selector configured to determine from the at least two images a reference image; and a parameter definer configured to define for an image other than the reference image at least two difference parameters, wherein the at least two difference parameters are stereo setup misalignments.

The camera definer may comprise: a parameter range definer configured to define a range of values within which the difference parameter value can be determined in the error search; and a parameter initializer configured to define an initial value for the difference parameter value determination in the error search.

The rectification determiner may comprises: a parameter selector configured to select a difference parameter, wherein the difference parameter has an associated defined initial value and value range; a camera rectification generator configured to generate a camera rectification dependent on the initial value of the difference parameter; a metric determiner configured to generate a value of the error criterion dependent on the camera rectification and at least one matched feature; and a metric value comparator configured to control repeatedly selecting a further difference parameter value, generating a camera rectification and generating a value of the error criterion until a smallest value of the error criterion is found for the difference parameter; and control repeatedly selecting a further difference parameter until all of the at least two difference parameters have determined values for the difference parameters which minimise the error search.

The apparatus may further comprise: a first camera configured to generate a first image of the at least two images; and a second camera configured to generate a second image of the at least two images.

The apparatus may further comprise: a first camera configured to generate a first image of the at least two images with a first camera at a first position; and generate a second image of the at least two images at a second position displaced from the first position.

According to a fourth aspect of the application there is provided an apparatus comprising: means for means for analysing at least two images to determine at least one matched feature; means for determining at least two difference parameters between the at least two images; and means for determining values for the at least two difference parameters in an error search using an error criterion based on the at least one matched feature in the at least two images and an estimated difference parameter value, wherein the value for each difference parameter is determined serially.

The means for determining values for the at least two difference parameters in an error search may comprise means for determining values for the at least two parameters to minimise the error search.

The means for analysing at least two images to determine at least one matched feature may comprise: means for determining at least one feature from a first image of the at least two images; means for determining at least one feature from a second image of the at least two images; and means for matching at least one feature from the first image and at least one feature from the second image to determine the at least one matched feature.

Analysing the at least two images to determine at least one matched feature may further comprise means for filtering the at least one matched feature.

The means for filtering the at least one matched feature may comprise at least one of: means for removing matched features occurring within a threshold distance of the image boundary; means for removing repeated matched features; means for removing distant matched features; means for removing intersecting matched features; means for removing non-consistent matched features; and means for selecting a sub-set of the matches according to a determined matching criteria.

The means for determining at least two difference parameters between at least two images may comprise: means for determining from the at least two images a reference image; and means for defining for an image other than the reference image at least two difference parameters, wherein the at least two difference parameters are stereo setup misalignments.

The means for determining at least two difference parameters between at least two images may comprise: means for defining a range of values within which the difference parameter value can be determined in the error search; and means for defining an initial value for the difference parameter value determination in the error search.

The means for determining values for the difference parameters in the error search may comprise: means for selecting a difference parameter, wherein the difference parameter has an associated defined initial value and value range; means for generating a camera rectification dependent on the initial value of the difference parameter; means for generating a value of the error criterion dependent on the camera rectification and at least one matched feature; means for repeatedly selecting a further difference parameter value, generating a camera rectification and generating a value of the error criterion until a smallest value of the error criterion is found for the difference parameter; and means for repeatedly selecting a further difference parameter until all of the at least two difference parameters have determined values for the difference parameters which minimise the error search.

The apparatus may further comprise: means for generating a first image of the at least two images with a first camera; and means for generating a second image of the at least two images with a second camera.

The apparatus may further comprise: means for generating a first image of the at least two images with a first camera at a first position; and means for generating a second image of the at least two images with the first camera at a second position displaced from the first position.

The error criterion may comprise at least one of: a Sampson distance metric; a symmetric epipolar distance metric; a vertical feature shift metric; a left-to-right consistency metric; a mutual area metric; and a projective distortion metric.

The difference parameter may comprise at least one of: a rotation shift; a Rotation Shift Pitch; a Rotation Shift Roll; a Rotation Shift Yaw; a translational shift; a translational shift on the Vertical (Y) Axis; a translation shift on the Depth (Z) Axis; a horizontal focal length difference; a vertical focal length difference; an optical distortion in the optical system; a difference in zoom factor; a non-rigid affine distortion; a Horizontal Axis (X) Shear; a Vertical Axis (Y) Shear; and a Depth (Z) Axis Shear.

A chipset may comprise apparatus as described herein.

Embodiments of the present application aim to address problems associated with the state of the art.

### SUMMARY OF THE FIGURES

For better understanding of the present application, reference will now be made by way of example to the accompanying drawings in which:

FIG. 1 shows schematically an apparatus or electronic device suitable for implementing some embodiments;

FIG. 2 shows schematically a Multi-Frame Image Calibration and Rectification Apparatus according to some embodiments;

FIG. 3 shows a flow diagram of the operation of the Multi-frame Image Calibration and Rectification apparatus as shown in FIG. 2;

FIG. 4 shows an example Image Analyzer as shown in FIG. 2 according to some embodiments;

FIG. 5 shows a flow diagram of the operation of the Image Analyzer as shown in FIG. 4 according to some embodiments;

FIG. 6 shows a flow diagram of the operation of the Matching Filter as shown in FIG. 4 according to some embodiments;

FIG. 7 shows schematically a Multi-camera Setup definer as shown in FIG. 2 according to some embodiments;

FIG. 8 shows a flow diagram of a Multi-camera Setup definer as shown in FIG. 6 according to some embodiments;

FIG. 9 shows schematically an example of the Camera Simulator as shown in FIG. 2 according to some embodiments;

FIG. 10 shows a flow diagram of the operation of the Camera Simulator according to some embodiments;

FIG. 11 shows schematically a Rectification optimizer as shown in FIG. 2 according to some embodiments;

FIG. 12 shows a flow diagram of the operation of the Rectification Optimizer shown in FIG. 10 according to some embodiments;

FIG. 13 shows schematically an example of rectification metrics used in Rectification Optimizer; and

FIG. 14 shows a flow diagram of the operation of Serial Optimizer example according to some embodiments.

### EMBODIMENTS OF THE APPLICATION

The following describes suitable apparatus and possible mechanisms for the provision of effective multiframe image calibration and processing for producing stereo or three dimensional video capture apparatus.

The concept described herein relates to assisting calibration and rectification as pre-processing steps in stereo and multi-frame camera capturing applications. In previous studies, it has been shown that the quality of depth from stereo estimation strongly depends on the precision of the stereo camera setup. For example, even slight misalignments of calibrated cameras degrade the quality of depth estimation. Such misalignments can be due to mechanical changes in the setup and require additional post calibration and rectification. Calibration approaches aiming at the highest precision use calibration patterns to capture features at known positions. However this is not a task which is suitable to be carried out by an ordinary user of a stereo camera.

Image alignment is also a required step in multi-frame imaging due to camera movement between consecutive images. The methods known for calibration and rectification for stereoscopic imaging and for alignment in multiframe imaging are computationally demanding. There is a desire to have low complexity calibration, rectification, and alignment methods for battery powered devices with relatively constrained computation capacity. The presented concept thus provides an accurate calibration and rectification without the requirement of calibration patterns and using only the information available from the captured data of real scenes. It is therefore aimed at specifically types of setup misalignments or changes of camera parameters and is able to identify problematic stereo pairs or sets of images for multi-frame imaging and provide quantitative measurements of the rectification and/or alignment quality. Furthermore the approach as described herein can enable a low complexity implementation in other words able to be implemented on relatively low computationally powered battery apparatus.

Current approaches for stereo calibration and rectification of un-calibrated setups are based mainly on estimation of epipolar relations of camera setup described by the so called Fundamental (F) matrix. This matrix can be estimated from a sufficient number of corresponding pairs of feature points, found in stereo image pairs. Having F estimated, it is possible to obtain all of the parameters required for stereo calibration and rectification. The matrix F is of size 3×3 elements, and has 8 degrees of freedom formed as ratios between matrix elements. The matrix F has no full rank, and thus lacks uniqueness and exhibits numerical instability while estimated by least-squares methods. The quality and robustness of the matrix estimation strongly depends on the location precision of the used features, the number of correspondences, and the percentage of outliers. A general solution for F-matrix estimation requires the following rather complex steps: point normalization, extensive search of correspondences by robust maximum likelihood approaches, minimising a non-linear cost function, and Singular Value Decomposition (SVD) analysis.

A general solution as presented by Hartley and Zissermann in “Multi-view Geometry in Computer Vision, Second Edition” has been improved over time, however, tests with available corresponding points to rectification applications have demonstrated that the methods still exhibit problems such as high complexity, degraded performance, or unstable results for the same input parameters.

The approach as described herein allows calibration of roughly aligned cameras in a stereo setup, where the camera position and/or other camera parameters are varied within limits expected for such setups. This approach allows for selecting arbitrary subsets of camera parameters to be varied thus allowing for a very efficient compromise between performance and estimation speed. Camera parameters may include but are not limited to the following:
Camera position or translational shift between cameras
Horizontal and vertical focal length
Optical distortion
Camera rotations along different axes; e.g. pitch, yaw and roll

A linear optimisation procedure for finding the optimal values of parameters can be performed. The minimization criteria used in the optimization procedure are based on some global rectification cost metrics. The assumption of roughly aligned cameras allows for a good choice of the initial values of parameters being optimized. The approach as described herein effectively avoids computationally demanding non-linear parameter search and optimisation cost functions.

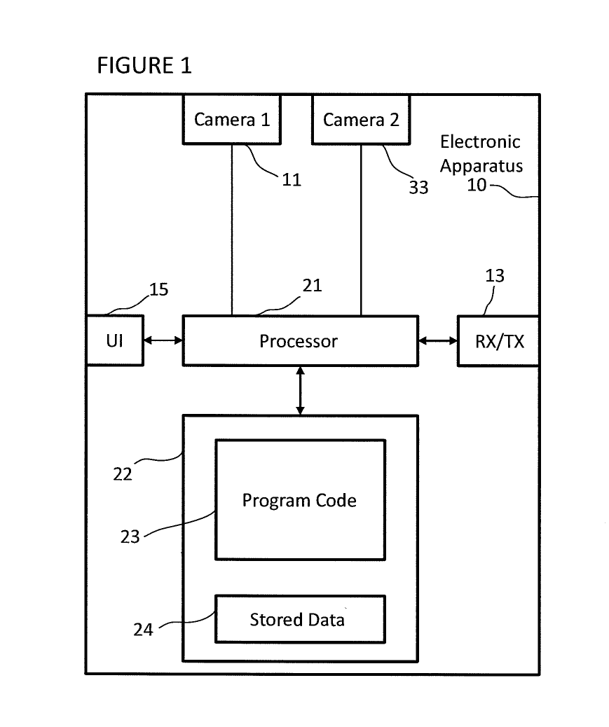

FIG. 1 shows a schematic block diagram of an exemplary apparatus or electronic device 10, which may be used to record or capture images, and furthermore images with or without audio data and furthermore can implement some embodiments of the application.

The electronic device 10 may for example be a mobile terminal or user equipment of a wireless communication system. In some embodiments the apparatus can be a camera, or any suitable portable device suitable for recording images or video or audio/video such as a camcorder or audio or video recorder.

In some embodiments the apparatus 10 comprises a processor 21. The processor 21 is coupled to the cameras. The processor 21 can be configured to execute various program codes. The implemented program codes can comprise for example image calibration, image rectification and image processing routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a visual imaging subsystem. The visual imaging subsystem can in some embodiments comprise at least a first camera, Camera 1, 11, and a second camera, Camera 2, 33 configured to capture image data. The cameras can comprise suitable lensing or image focus elements configured to focus images on a suitable image sensor. In some embodiments the image sensor for each camera can be further configured to output digital image data to processor 21. Although the following example describes a multi-frame approach where each frame is recorded by a separate camera it would be understood that in some embodiments a single camera records a series of consecutive images which may be processed with various embodiments, such as the following example embodiment describing the multi-frame approach.

Furthermore, in some embodiments a single camera is used, but the camera may include an optical arrangement, such as micro-lenses, and/or optical filters passing only certain wavelength ranges. In such arrangements, for example, different sensor arrays or different parts of a sensor array may be used to capture different wavelength ranges. In another example, a lenslet array is used, and each lenslet views the scene at a slightly different angle. Consequently, the image may consist of an array of micro-images, each corresponding to one lenslet, which represent the scene captured at slightly different angles. Various embodiments may be used for such camera and sensor arrangements for image rectification and/or alignment.

It is to be understood again that the structure of the electronic device 10 could be supplemented and varied in many ways.

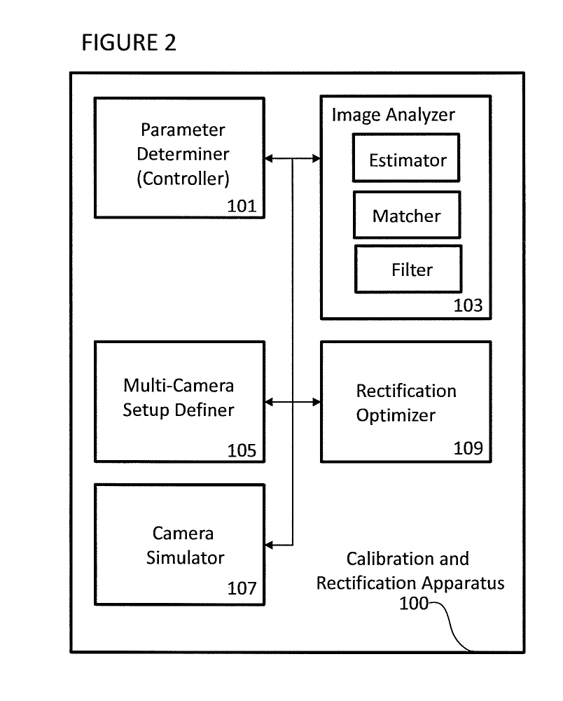

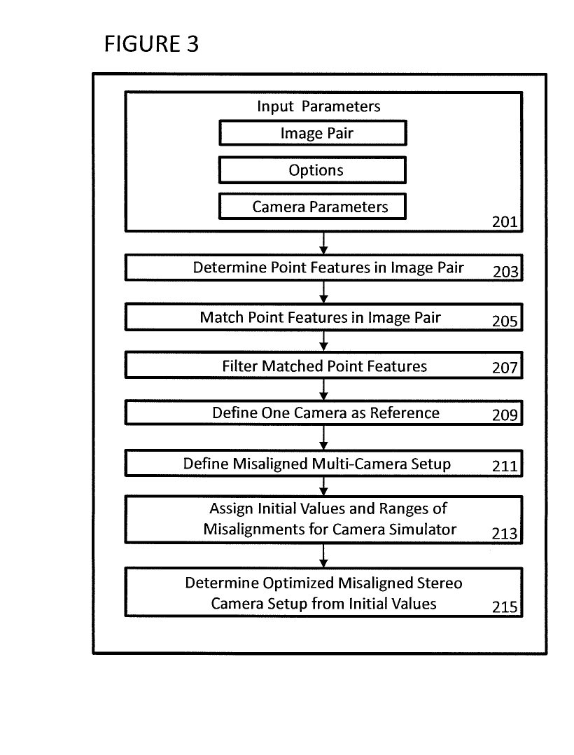

With respect to FIG. 2 a Calibration and Rectification Apparatus overview according to some embodiments is described. Furthermore, with respect to FIG. 3, the operation of the Calibration and Rectification Apparatus as shown in FIG. 2 is described in further detail.

In some embodiments the Calibration and Rectification Apparatus 100 comprises a parameter determiner 101. The Parameter Determiner 101 can in some embodiments be configured to be the Calibration and Rectification Apparatus controller configured to receive the information inputs and control the other components to operate in such a way to generate a suitable calibration and rectification result.

In some embodiments the Parameter Determiner can be configured to receive input parameters. The input parameters can be any suitable user interface input such as options controlling the type of result required (calibration, rectification, and/or alignment of the cameras). Furthermore the parameter determiner 101 can be configured to receive inputs from the cameras such as the stereo image pair (or for example in some embodiments where a single camera captures successive images, the Successive Images). Furthermore, although in the following examples a stereo pair of images are calibrated and rectified it would be understood that this can be extended to multiframe calibration, and rectification where a single camera of pair of cameras is selected as a reference and the calibration, rectification and/or alignment is carried out between each pair for all of or at least some of the cameras.

In some embodiments the parameter determiner 101 can further be configured to receive camera parameters. The camera parameters can be any suitable camera parameter such as information concerning the focal lengths and zoom factor, or whether there are any optical system distortions known.

The operation of receiving the input camera parameters is shown in FIG. 3 by step 201.

The parameter determiner 101 in some embodiments can then pass the image pair to the Image Analyser 103.

In some embodiments the Calibration and Rectification Apparatus comprises an Image Analyser 103. The Image Analyser 103 can be configured to receive the image pair and analyse the image to estimate point features in the image pair.

The operation of estimating point features in the image pair is shown in FIG. 3 by step 203.

Furthermore the Image Analyser 103 in some embodiments can be configured to match the estimated point features and filter outliers in the image pair.

The operation of matching the point features in the image pair is shown in FIG. 3 by step 205.

The operation of filtering the point features in the image pair is shown in FIG. 3 by step 207.

The matched and estimated features that are filtered from outliers can then be output from the image analyser.

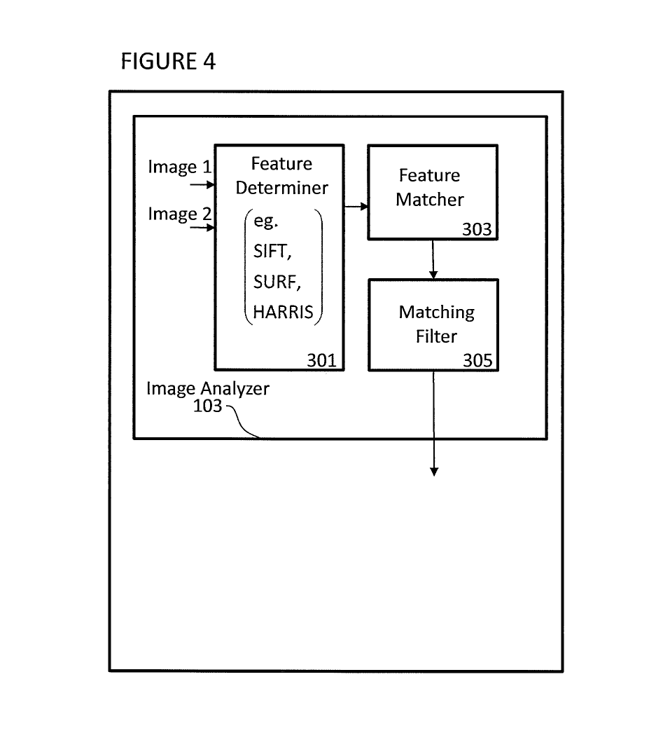

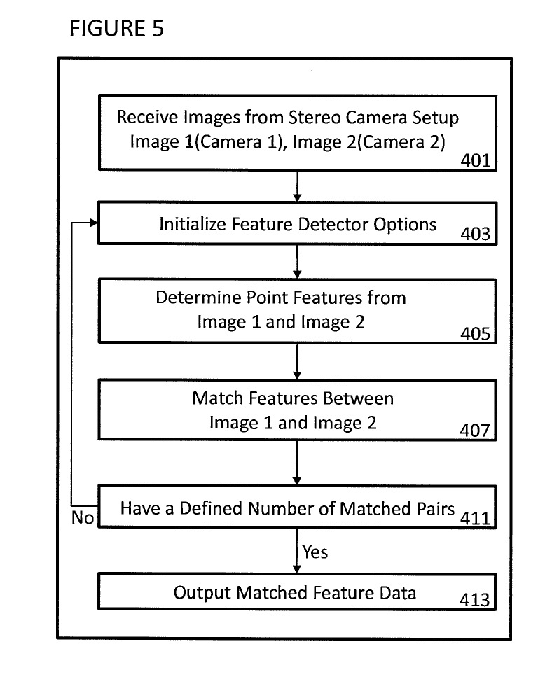

With respect to FIG. 4 an example Image Analyser according to some embodiments is shown in further detail. Furthermore, with respect to FIG. 5, a flow diagram of an example operation of the image analyser shown in FIG. 4 according to some embodiments is described.

The Image Analyser 103 in some embodiments can be configured to receive the image frames from the cameras, Camera 1 and Camera 2.

The operation of receiving the images from the cameras (in some embodiments via the Parameter Determiner) is shown in FIG. 5 by step 401.

In some embodiments the Image Analyser comprises a Feature estimator 301. The Feature estimator 301 is configured to receive the images from the cameras and further be configured to determine from each image a number of features. The initialization of the feature detection options is shown in FIG. 5 by step 403.

The Feature Determiner can use any suitable edge, corner or other image feature estimation process. For example, in some embodiments the image feature estimator can use a Harris&Stephens Corner Detector (HARRIS), or a Scale Invariant Feature Transform (SIFT), or a Speeded Up Robust Feature transform (SURF).

The determined image features for the camera images can be passed to the Feature Matcher 303.

The operation of determining features for the image pair is shown in FIG. 5 by step 405.

In some embodiments the Image Analyser 103 comprises a Feature Matcher configured to receive the determined image features for the images from Camera 1 and Camera 2 and match the determined features. The Feature Matcher can implement any known automated, semi-automated or manual matching. For example, SIFT feature detectors represents information as a collection of feature vector data called descriptors. The points of interest are considered for those areas, where the vector data remains invariant to different image geometry transforms or other changes (noise, optical system distortions, illumination, local motion). In some embodiments, the matching process is performed by some nearest neighbour search (e.g. K-D Tree Search Algorithm) in order to sort features by vector distance of their descriptors. A matched pair of feature points is considered one of those corresponding points, which has the smallest distance score compared to all other possible pairs.

The operation of matching features between the image for Camera 1 (Image 1) and image for Camera 2 (Image 2) is shown in FIG. 5 by step 407.

The Feature Matcher in some embodiments is configured to check or determine whether a defined number of features have been matched.

The operation of checking whether a defined number of features have been matched is shown in FIG. 5 by step 411.

When an insufficient number of features have been matched then the image feature matcher 303 is configured to match further features between images of Camera 1 and Camera 2 (Camera 1 in first position and Camera 2 in second position) by other feature matching method, or matching parameters, or image pair. In other words the operation passes back to step 403 of FIG. 5.

When a sufficient number of matched pairs are detected, then the output data of matched information may be passed to Matching Filter 305 of FIG. 4 as described hereafter.

The operation of outputting the matched feature data is shown in FIG. 5 by step 413.

In some embodiments the image analyser 103 comprises a Matching Filter 305. The Matching Filter 305 can in some embodiments follow the feature matching (205, 303) by filtering of feature points or matched feature point pairs. Such filtering can in some embodiments remove feature points and/or matched feature point pairs that are likely to be outliers. Hence, such filtering may speed up subsequent steps in the rectification/alignment described in various embodiments, and make the outcome of the rectification/alignment more reliable.

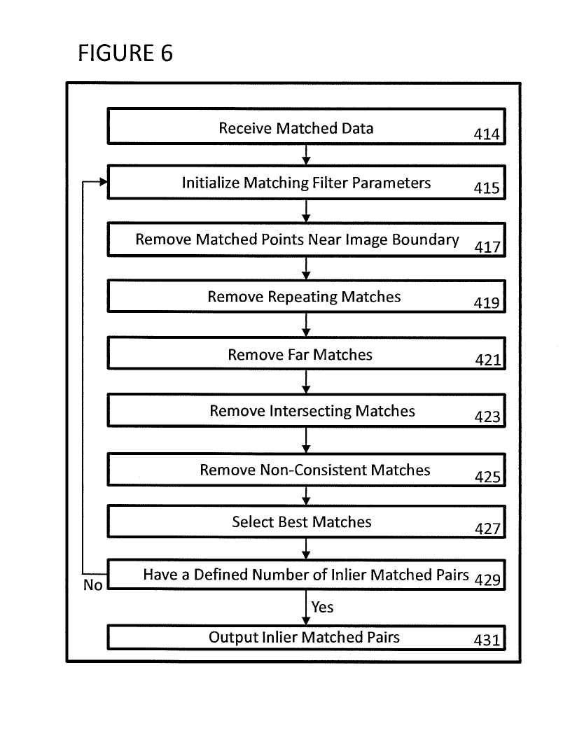

The operation of the Matching Filter 305 according to some embodiments can be shown with respect to FIG. 6.

The Matching Filter in some embodiments is configured to discard possible outliers among matched pairs. For example, the Matching Filter 305 can in some embodiments use one or more of the filtering steps shown in FIG. 6. It is to be understood that the order of performing the filtering steps in FIG. 6 may also be different than that illustrated.

In some embodiments the Matching Filter 305 is configured to receive the matched feature data or feature point pairs. This data or matching point pairs can in some embodiment be received from the output process described with respect to FIG. 5.

The operation of receiving the matched data is shown in FIG. 6 by step 414.

In some embodiments the Matching Filter 305 is configured is configured to initialize zero or more filter parameters affecting the subsequent filtering steps.

The initialization of the filter parameter is shown in FIG. 6 by step 415.

In some embodiments the Matching Filter 305 is configured to remove Matching pairs that are close to image boundaries. For example, matching pairs of which at least one of the matched feature points has a smaller distance to the image boundary than a threshold may be removed. In some embodiments the threshold value may be one of the parameters initialized in step 415.

The removal of matched points near the image boundary is shown in FIG. 6 by step 417.

In some embodiments the Matching Filter 305 is configured to discard any Matching pairs that share the same corresponding point or points.

The discarding of matching pairs that share the same corresponding point or points (repeating matches) is shown in FIG. 6 by step 419.

In some embodiments the Matching Filter 305 is configured to discard any feature point pair outliers, when they are located too far away from each other. In some embodiments this can be determined by a distance threshold. In such embodiments the distance threshold value for considering feature points being located too far from each other may be initialized in step 415.

The discarding of distant or far pairs is shown in FIG. 6 by step 421.

In some embodiments the Matching Filter 305 is configured to discard any matched pairs that appear as intersecting to other matched pairs. For example, if a straight line connecting a matched pair intersects a number (e.g. two or more) straight lines connecting other matched pairs, the matched pair may be considered as outlier and removed.

The discarding of intersecting matches is shown in FIG. 6 by step 423.

In some embodiments the Matching Filter 305 is configured to discard any matched pairs that are not consistent when compared to matched pairs of inverse matching process (matching process between Image 2 and Image 1).

The discarding of inconsistent or non-consistent matching pairs is shown in FIG. 6 by step 425.

Furthermore in some embodiments the Matching Filter 305 is configured to select a subset of best matched pairs according to initial matching criteria. For example using SIFT descriptors distance score a subset of matched pairs can be considered as inliers and the other matched pairs may be removed.

The selection of a sub-set of matching pairs defining a ‘best’ match analysis is shown in FIG. 6 by step 427.

In some embodiments the Matching Filter 305 can be configured to analyse or investigate the number of matched pairs that have not been removed.

The investigation of the number of remaining (filtered) matched pairs is shown in FIG. 6 by step 429.

If that number meets a criterion or criteria, e.g. exceeds a threshold (which in some embodiments can have been initialized in step 415), the filtering process may be considered completed. In some embodiments the completion of the filtering causes the output of any matched pairs that have not been removed.

The operation of outputting the remaining matched pairs is shown in FIG. 6 by step 431.

If the number of matched pairs that have not been removed (the remaining matched pairs) does not meet the criteria, the filtering process can in some embodiments be repeated with another parameter value initialization in step 415.

For example, when an insufficient number of features have been filtered, then the Matching Filter 305 can be configured to filter further matched features by other collection of filtering steps, or filter parameters, or matched data from other image pair. In other words, the operation passes back to step 415 of FIG. 6.

In some embodiments, the matched pairs that were removed in a previous filtering process are filtered again, while in other embodiments, the matched pairs that were removed in a previous filtering process are not subject to filtering and remain removed for further filtering iterations.

When a sufficient number of features have been considered as inliers after Matching Filter process in 305, then the Image Analyser 103 is configured to output the matched features data to the rectification optimiser 109.

The operation of outputting the matched feature data is shown in FIG. 6 by step 431.

In some embodiments the calibration and rectification apparatus comprises a Multi-Camera Setup Definer 105. The Multi-Camera Setup Definer 105 is configured to receive parameters from the Parameter Determiner 101 and define which camera or image is the reference and which camera or image is the non-reference or misaligned camera or image to be calibrated for.

The operation of defining one camera as reference and defining the other misaligned camera in their setup is shown in FIG. 3 by step 209.

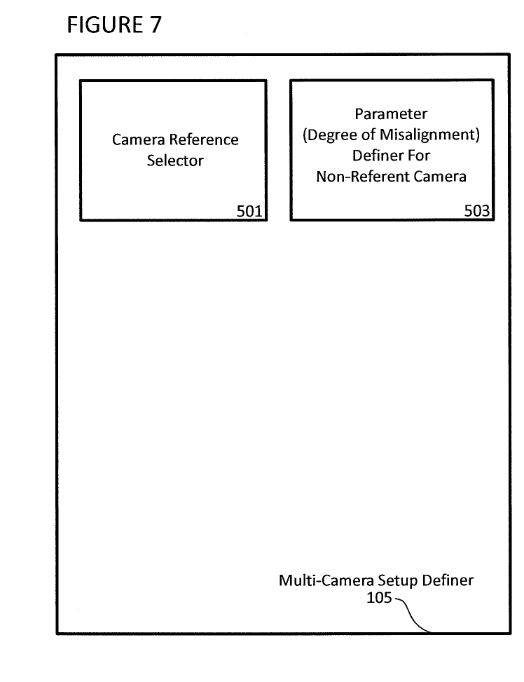

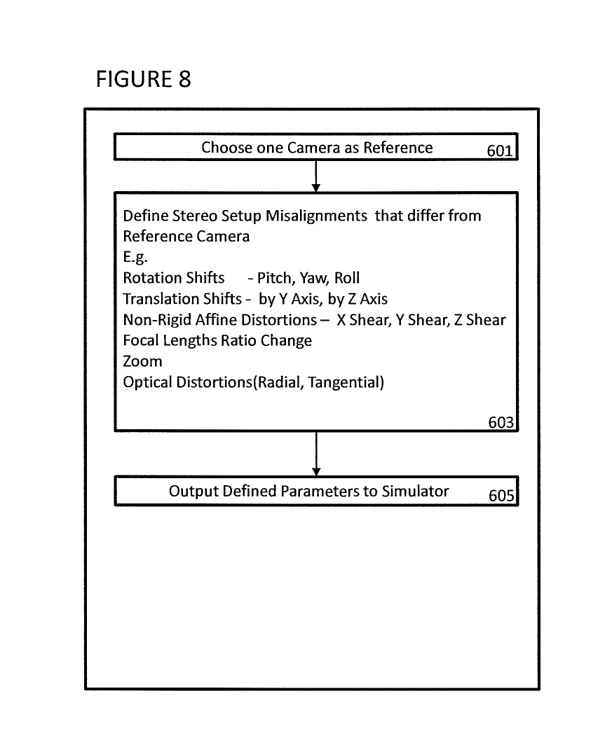

Furthermore, with respect to FIG. 7, a Multi-Camera Setup Definer 105 as shown in FIG. 2 is explained in further details. Furthermore, with respect to FIG. 8, a flow diagram shows the operation of the Multi-Camera Setup Definer as shown in FIG. 7 and according to some embodiments.

The Multi-Camera Setup Definer 105 in some embodiments comprises a Reference Selector 501. The Reference Selector 501 can be configured to define which camera (or image) is the reference camera (or image).

In some embodiments the Reference Selector 501 defines or selects one of the cameras (or images) as the reference. For example the Reference Selector 501 can be configured to select the “Left” camera as the reference. In other embodiments the Reference Selector 501 can be configured to receive an indicator, such as a user interface indicator defining which camera or image is the reference image and selecting that camera (or image).

The operation of defining which camera is the reference camera is shown in FIG. 8 by step 601.

Furthermore, in some embodiments the Multi-Camera Definer 105 comprises a Parameter (Degree of Misalignment) Definer 503. The Parameter Definer 503 is configured to define degrees of misalignment or parameters defining degrees of misalignment for the non-reference camera (or image). In other words the Parameter Definer 503 defines parameters which differ from or are expected to differ from the reference camera (or image).

In some embodiments, these parameters or degrees of misalignment which differ from the reference camera can be a rotation shift, such as: Rotation Shift Pitch; Rotation Shift Roll; and Rotation Shift Yaw. In some embodiments the parameter or degree of misalignment can be a translational shift such as: a translational shift on the Vertical (Y) Axis; or a translation shift on the Depth (Z) Axis. In some embodiments the parameters can be the horizontal and vertical focal length difference between Camera 1 and Camera 2 (or Image 1 and Image 2). In some embodiments, the parameter or degree of misalignment can be whether there is any optical distortion in the optical system between the reference camera and non-reference camera (or images). In some embodiments, the parameters can be the difference in zoom factor between cameras. In some embodiments, the parameters or degrees of misalignment definition can be non-rigid affine distortions such as: Horizontal Axis (X) Shear, Vertical Axis (Y) Shear, Depth (Z) Axis Shear. In some embodiments, the defined camera setup is one where the first reference camera and non-reference camera is shifted by rotations of Pitch, Yaw and Roll, translation displacement in the Y and Z axis (this can be known as the 5-degrees of Misalignment [5 DOM] definition).

The operation of defining the parameters (Degrees of Misalignment) is shown in FIG. 8 by step 603.

The Multi-Camera Setup Definer 105 can then be configured to output the simulated parameters to the Camera Simulator 107.

The operation of outputting the defined parameters to the Camera Simulator is shown in FIG. 8 by step 605.

In some embodiments, the Calibration and Rectification apparatus comprises a Camera Simulator 107. The Camera Simulator can be configured to receive the determined parameters or degrees of misalignment from the Multi-Camera Setup Definer 105 and configure a parameter range and initial value for each parameter defined.

The operation of assigning initial values and ranges for the parameters is shown in FIG. 3 by step 213.

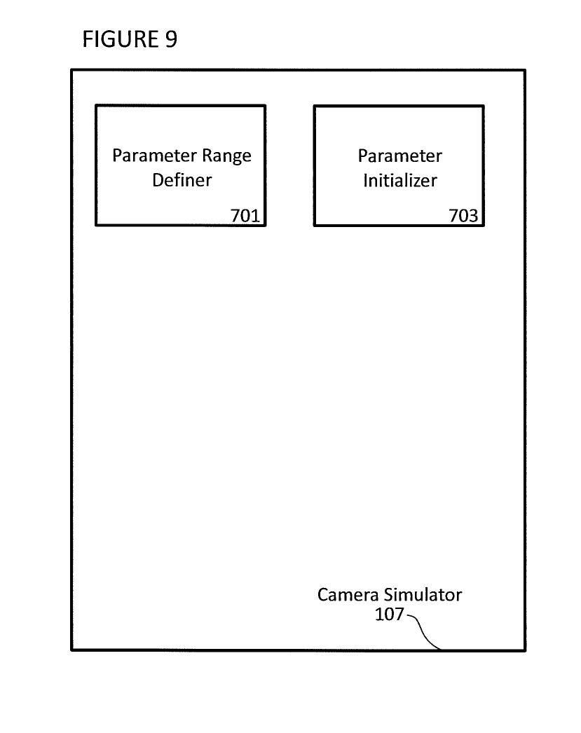

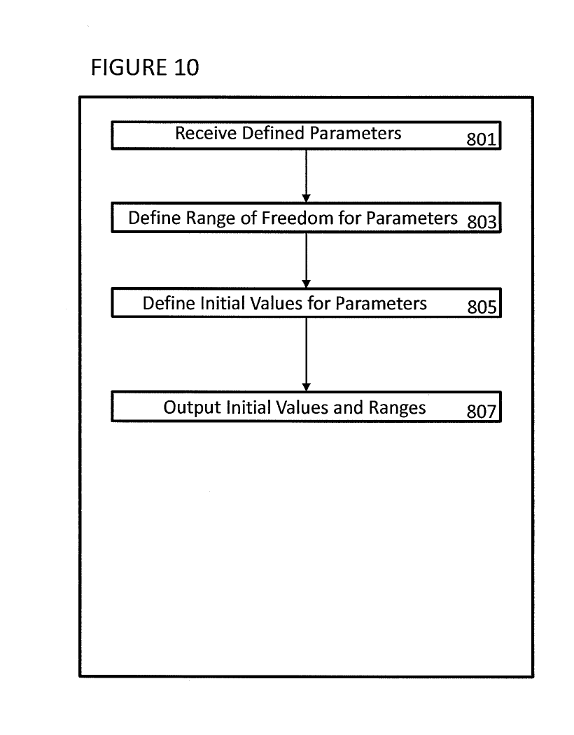

With respect to FIG. 9 a schematic view of an example Camera Simulator 107 is shown in further detail. Furthermore with respect to FIG. 10 a flow diagram of the operation the Camera Simulator 107 according to some embodiments is shown.

The Camera Simulator 107 in some embodiments comprises a parameter range definer 701. The Parameter Range Definer 701 can be configured to receive the defined parameters from the Multi-Camera Setup Definer 105.

The operation of receiving the defined parameters is shown in FIG. 10 by step 801.

Furthermore, the parameter range definer 701 can define a range of misalignment about which the parameter can deviate. An expected level of misalignment can be for example plus or minus 45 degrees for a rotation and a plus or minus camera-baseline value for translational motion on the Y and Z axis.

The operation defining a range of misalignment for the parameters is shown in FIG. 10 by step 803.

In some embodiments the Camera Simulator 107 comprises a Parameter Initializer 703. The Parameter Initializer 703 is configured to receive the determined parameters and initialize each parameter such that it falls within the range defined by the Parameter Range Definer 701. In some embodiments the parameter initializer 703 can be configured to initialize the values with no error between the two cameras. In other words the parameter initializer 703 is configured to initialize the rotations at zero degrees and the translations at zero. However in some embodiments, for example when provided an indicator from the user interface or a previous determination, the Parameter Initializer 703 can define other initial values.

The operation of defining initial values for the parameters is shown in FIG. 10 by step 805.

The Parameter Initializer 703 and the Parameter Range Definer 701 can then output the initial values and the ranges for each of the parameters to the Rectification Optimizer 109.

The operation of outputting the initial values and the range is shown in FIG. 10 by step 807.

In some embodiments, the Calibration and Rectification Apparatus 100 comprises a Rectification Optimizer 109. The Rectification Optimizer 109 is configured to receive the image features matched by the Image Analyser 103 and the camera simulated values from the Camera Simulator 107 and perform an optimized search for rectification parameters between the images.

The operation of determining an optimized set of rectification parameters from the initial values is shown in FIG. 3 by step 215.

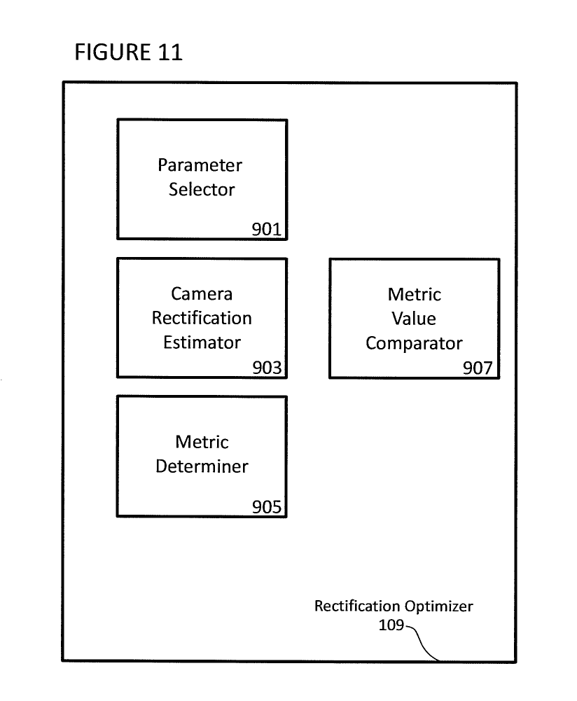

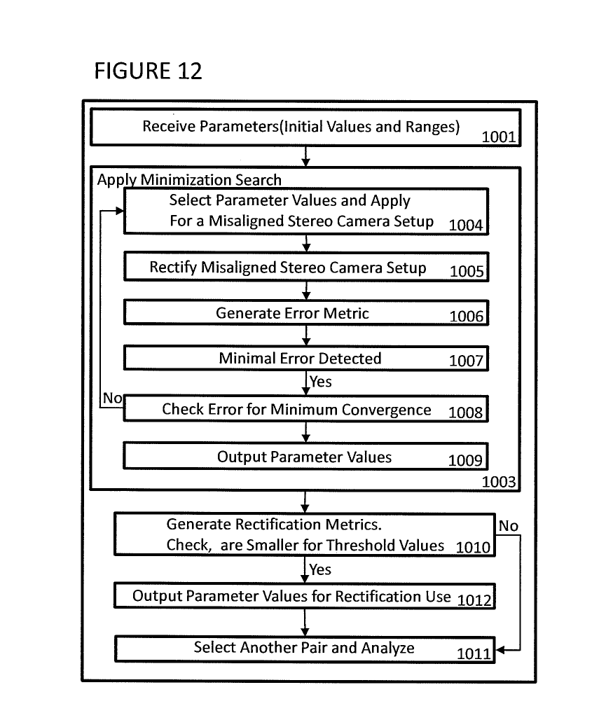

Furthermore, with respect to FIG. 11 an example schematic view of the Rectification Optimizer 109 is shown. Furthermore, with respect to FIG. 12, a flow diagram of the operation of the Rectification Optimizer 109 shown in FIG. 11 is explained in further detail.

In some embodiments, the Rectification Optimizer 109 comprises a Parameter Selector 901. The Parameter Selector 901 is configured to select parameter values. In some embodiments, the Parameter Selector 901 is initially configured to use the parameters determined by the Camera Simulator 107, however, in further iteration cycles the Parameter Selector 901 is configured to select parameter values depending on the optimization process used.

The operation of receiving the parameters in the form of initial values and ranges is shown in FIG. 12 by step 1001.

The Rectification Optimizer 109 can be configured to apply a suitable optimisation process. In the following example a minimization search is performed.

The operation of applying the minimization search is shown in FIG. 12 by step 1003.

Furthermore the steps of operations performed with regards to a minimization search according to some embodiments are described further.

The parameter selector 901 can thus select parameter values to be used during the minimization search.

The operation of selecting the parameter values is shown in FIG. 12 by sub step 1004.

In some embodiments the Rectification Optimizer 109 comprises a camera Rectification Estimator 903. The camera Rectification Estimator 903 can be configured to receive the selected parameter values and simulate the camera compensation for the camera rectification process for the matched features only.

The operation of simulating the camera compensation for the camera rectification process for matched features is shown in FIG. 12 by sub step 1005.

In some embodiments, the operation of compensation for rectified camera setup is performed by camera projective transform matrices for rotation and translation misalignments, by applying radial and tangential transforms for correction of optical system distortions, and applying additional non-rigid affine transforms to compensate difference in camera parameters.

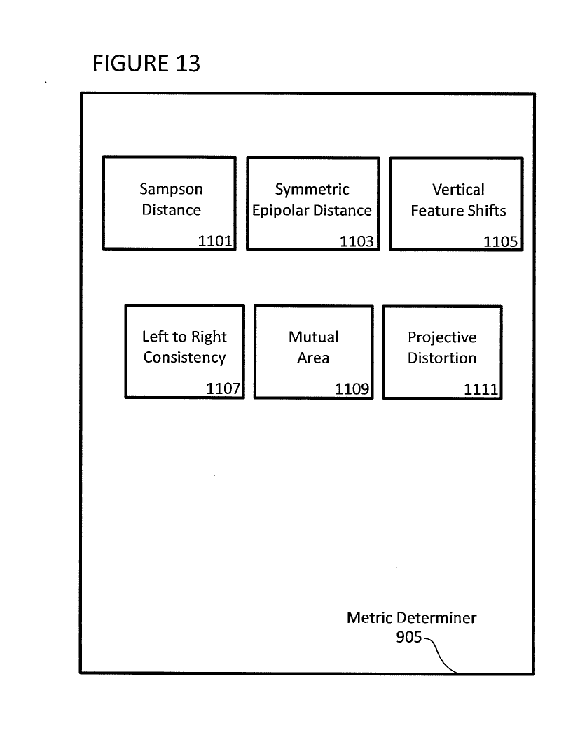

In some embodiments, the Rectification Optimizer 109 comprises a metric determiner 905 shown in FIG. 13. The metric determiner 905 can be configured to determine a suitable error metric in other words determining a rectification error. In some embodiments, the metric can be at least one of the geometric distance metrics like Sampson distance 1101, Symmetric Epipolar Distance 1103, Vertical Feature Shift Distance 1105 with a combination of Left-to-Right consistency metric 1107, Mutual Area Metric 1109, or Projective Distortion Metrics 1111. In some embodiments a combination of a two or more metrics such as some of the mentioned geometric distance metrics may be used, where the combination may be performed for example by normalizing the metrics to the same scale and deriving an average or a weighted average over the normalized metrics.

The Sampson Distance metric 1101 can be configured to calculate a First-order Geometric Distance Error by Sampson Approximation between projected epipolar lines and feature point locations among all matched pairs. Furthermore the Symmetric Distance metric 1103 can be configured to generate an error metric using a slightly different approach in calculation. In both the Sampson Distance metric 1101 and Symmetric Distance metric 1103 the projection of epipolar lines is performed by a Star Identity matrix that corresponds to Fundamental Matrix F of ideally rectified camera setup.

The Vertical Shift metric 1105 can be configured to calculate the vertical distance shifts of feature point locations among matched pairs. For all geometric distances among matched pairs, the metric result can in some embodiments be given both as standard deviation (STD) and Mean score values.

The Left-to-Right Consistency metric 1107 can be configured to indicate how rectified features are situated in horizontal direction. For example, in ideally rectified stereo setup, matched pairs of corresponding features should situate only in one direction (e.g. Left to Right direction). In other words, matched pairs should have positive horizontal shifts only. In some embodiments, the Left-to-Right Consistency metric weights the values of matched pairs of negative shifts to their number according to the number of all matched pairs.

The Mutual Area metric 1109 can be configured to indicate the mutual corresponding area of image data that is available among rectified cameras. In some embodiments, the mutual area is calculated as a percentage of original image area to the cropped area after camera compensation process. The Mutual Area metric 1109 does not evaluate quality of rectification, but only indicates a possible need of image re-sampling post-process steps (e.g. cropping, warping, and scaling).

The Projective Distortion metrics 1111 can be configured to measure the amount of introduced projective distortion in rectified cameras after compensation process. In some embodiments, Projective Distortion metrics calculate intersection angle between lines connecting middles of image edges or aspect ratio of the line segments connecting middles of image edges. Projective distortions will introduce intersection angle different from 90 degrees and aspect ratio different from non-compensated cameras. The Projective Distortion metrics are calculated and given separately for all compensated cameras in the misaligned setup.

The rectification error metric generated by the Metric Determiner 905 can then be passed to the Metric Value Comparator 907.

The step of generating the error metric is shown in FIG. 12 by sub step 1006.

In some embodiment the Rectification Optimizer comprises a metric comparator 907. The metric comparator 907 can be configured to determine whether a suitable error metric is within sufficient bounds or control the operation of the Rectification Optimizer otherwise.

The metric value comparator 907 can be configured in some embodiments to check the rectification error and particularly for checking whether the error metric is a minimum.

The step of checking the metric for the minimum value is shown in FIG. 12 by sub step 1007.

When the minimal error is not detected, then a further set of parameter values is selected, in other words the operation passes back to sub step 1004, where the parameter selector selects a new set of parameters for compensation in sub step 1005 based on the current metric values.

When a minimal error or convergence is detected then the minimization search can be ended and the parameters output.

The output of the parameter values from the minimization search operation is shown by sub step 1009.

In some embodiments the metric value comparator 907 can then receive the minimization search output check, whether the rectification error metrics are lower than a determined threshold values.

The operation of checking the rectification metrics is shown in FIG. 12 by step 1010.

When the rectification values are lower than the threshold values, the metric value comparator 907 can output the rectification values for further use.

The operation of outputting the parameters of misalignment and values for rectification use is shown in FIG. 12 by step 1012.

Where the rectification metric scores are higher than threshold values then it have been determined that the pair of images are difficult images and a further pair of images is selected to be analysed in other words the operation of image analysis is repeated followed by a further rectification optimization operation.

The operation of selecting new image pairs and analysing these is shown in FIG. 12 by step 1011.

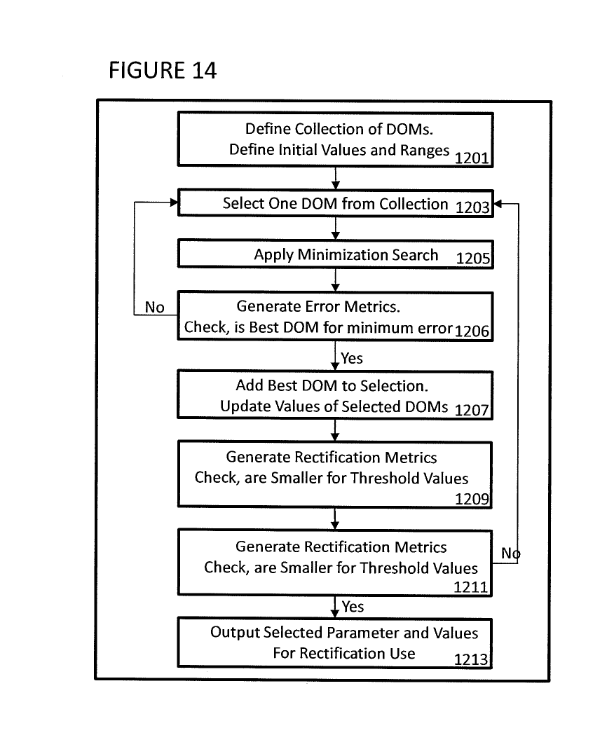

An example operation of some embodiment operating a Serial Optimizer for the minimisation of the error metric is shown in FIG. 14, wherein an error criterion is optimized for one additional degree of misalignment (DOM) at a time. The selection of additional DOM is based on best performed DOMs that minimize current optimization error. The Serial Optimizer can in some embodiments perform an initialization operation. The initialization includes the preparation of a collection of arbitrarily chosen DOMs as embodied in step 603 and shown in FIG. 8. That collection will be searched for rectification compensation in minimization process. The parameter input values and ranges are configured according to Parameter Initializer 703, shown in FIG. 9.

The performance of an initialization operation for the optimization is shown by sub step 1201.

Furthermore, the Serial Optimizer can in some embodiments selects one DOM from the DOMs collection.

The operation of selecting the one DOM from the DOMs collection is shown by sub step 1203 and added to selection of DOMs for minimization search.

The Serial Optimizer can in some embodiments then apply a minimization search operation for current DOM selection.

The operation of applying a minimization search for the current DOM selection is shown in FIG. 14 by sub step 1205.

The Serial Optimizer can in some embodiments repeat for all available DOMs in collection, which are not currently included in selection (in other words pass back to sub step 1203).

The generate error metric operation is shown in FIG. 14 by sub step 1206.

The Serial Optimizer can in some embodiments then select the best performed DOM, in other words adding the best performed DOM to the selection list.

The operation of adding the best performed DOM to the selection is shown in sub step 1207.

The Serial Optimizer can in some embodiments update the input optimization values of all currently selected DOMs.

The updating of the input optimization values of all currently selected DOMs is shown by sub step 1209 in FIG. 14.

The Serial Optimizer can in some embodiments perform a check that the minimum value of optimization error of currently selected DOMs is lower than determined threshold values.

The operation of checking the metric of minimum value is in sub step 1211.

When the minimum value of optimization error of currently selected DOMs is lower than determined threshold values, then the minimization search ends and the parameters of selection are output.

The operation of outputting the parameters of selected DOMs and corresponding values is shown by sub step 1213 in FIG. 14.

When the minimum value is higher than determined threshold values, then a further selection process continues. In other words, the operation passes back to sub step 1205.

It would be understood that the embodiments of the application lead to a low cost implementation as they avoid completely the estimation of the fundamental matrix F or any other use of epipolar geometry for rectification based on non-linear estimation or optimization approaches. The implementations as described with regards to embodiments of the application show very fast convergence typically for 40 iterations of a basic minimization algorithm or less than 200 iterations or a basic genetic algorithm resulting in very fast performance.

Comparisons with non-linear estimations such as Random Consensus Search approach (RANSAC) in terms of number of multiplications show approximately a five times speed up for the worst scenario of our optimisation against the best scenario for the non-linear RANSAC operation. Furthermore the proposed implementation is agnostic with regards to the number of parameters and degrees of misalignment to be optimized. Thus, the number of degrees of misalignments can be varied on an application specific manner as to trade of generality against the solution for speed. The approach has been successfully tested for robustness in sub pixel feature noise and present of high proportion of outliers.

It shall be appreciated that the term user equipment is intended to cover any suitable type of wireless user equipment, such as mobile telephones, portable data processing devices or portable web browsers.

In general, the various embodiments of the invention may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-27. (canceled)

28. A method comprising:
analysing at least two images to determine at least one matched feature;
determining at least two difference parameters between the at least two images; and
determining values for the at least two difference parameters in an error search using an error criterion based on the at least one matched feature in the at least two images and an estimated difference parameter value, wherein the value for each difference parameter is determined serially.

29. The method as claimed in claim 28, wherein determining values for the at least two difference parameters in an error search comprises determining values for the at least two parameters to minimise the error search.

30. The method as claimed in claim 28, wherein analysing at least two images to determine at least one matched feature comprises:
determining at least one feature from a first image of the at least two images;
determining at least one feature from a second image of the at least two images; and
matching at least one feature from the first image and at least one feature from the second image to determine the at least one matched feature.

31. The method as claimed in claim 30, wherein analysing at least two images to determine at least one matched feature further comprises filtering the at least one matched feature.

32. The method as claimed in claim 31, wherein filtering the at least one matched feature comprises at least one of:
removing matched features occurring within a threshold distance of the image boundary;
removing repeated matched features;
removing distant matched features;
removing intersecting matched features;
removing non-consistent matched features; and
selecting a sub-set of the matches according to a determined matching criteria.

33. The method as claimed in claim 28, wherein determining at least two difference parameters between at least two images comprises:
determining from the at least two images a reference image;
defining for an image other than the reference image at least two difference parameters, wherein the at least two difference parameters are stereo setup misalignments.

34. The method as claimed in claim 28, wherein determining at least two difference parameters between at least two images comprises:
defining a range of values within which the difference parameter value can be determined in the error search; and
defining an initial value for the difference parameter value determination in the error search.

35. The method as claimed in claim 28, wherein determining values for the difference parameters in the error search comprises:
selecting a difference parameter, wherein the difference parameter has an associated defined initial value and value range;
generating a camera rectification dependent on the initial value of the difference parameter;
generating a value of the error criterion dependent on the camera rectification and at least one matched feature;
repeating selecting a further difference parameter value, generating a camera rectification and generating a value of the error criterion until a smallest value of the error criterion is found for the difference parameter; and
repeating selecting a further difference parameter until all of the at least two difference parameters have determined values for the difference parameters which minimise the error search.

36. The method as claimed in claim 28, further comprising:
generating a first image of the at least two images with a first camera; and
generating a second image of the at least two images with a second camera.

37. The method as claimed in claim 28, further comprising:
generating a first image of the at least two images with a first camera at a first position; and
generating a second image of the at least two images with the first camera at a second position displaced from the first position.

38. The method as claimed in claim 28, wherein the error criterion comprises at least one of:
a Sampson distance metric;
a symmetric epipolar distance metric;
a vertical feature shift metric;
a left-to-right consistency metric;
a mutual area metric; and
a projective distortion metric.

39. The method as claimed in claim 28, wherein the difference parameter comprises at least one of:
a rotation shift;
a Rotation Shift Pitch;
a Rotation Shift Roll;
a Rotation Shift Yaw;
a translational shift;
a translational shift on the Vertical (Y) Axis;
a translation shift on the Depth (Z) Axis;
a horizontal focal length difference;
a vertical focal length difference;
an optical distortion in the optical system;
a difference in zoom factor;
a non-rigid affine distortion;
a Horizontal Axis (X) Shear;
a Vertical Axis (Y) Shear; and
a Depth (Z) Axis Shear.

40. An apparatus comprising at least one processor and at least one memory including computer code for one or more programs, the at least one memory and the computer code configured to with the at least one processor cause the apparatus to at least to:
analyse at least two images to determine at least one matched feature;
determine at least two difference parameters between the at least two images; and
determine values for the at least two difference parameters in an error search using an error criterion based on the at least one matched feature in the at least two images and an estimated difference parameter value, wherein the value for each difference parameter is determined serially.

41. The apparatus as claimed in claim 40, wherein the apparatus caused to determine values for the at least two difference parameters in an error search is further caused to determine values for the at least two parameters to minimise the error search.

42. The apparatus as claimed in claim 40, wherein the apparatus caused to analyse at least two images to determine at least one matched feature is further caused to:
determine at least one feature from a first image of the at least two images;
determine at least one feature from a second image of the at least two images; and
match at least one feature from the first image and at least one feature from the second image to determine the at least one matched feature.

43. The apparatus as claimed in claim 42, wherein the apparatus caused to analyse at least two images to determine at least one matched feature is further caused to filter the at least one matched feature.

44. The apparatus as claimed in claim 43, wherein the apparatus caused to filter the at least one matched feature is further caused to at least one of:
remove matched features occurring within a threshold distance of the image boundary;
remove repeated matched features;
remove distant matched features;
remove intersecting matched features;
remove non-consistent matched features; and
select a sub-set of the matches according to a determined matching criteria.

45. The apparatus as claimed in claim 40, wherein the apparatus caused to determine at least two difference parameters between at least two images is further caused to:
determine from the at least two images a reference image; and
define for an image other than the reference image at least two difference parameters, wherein the at least two difference parameters are stereo setup misalignments.

46. The apparatus as claimed in claim 40, wherein the apparatus caused to determine at least two difference parameters between at least two images is further caused to:
define a range of values within which the difference parameter value can be determined in the error search; and
define an initial value for the difference parameter value determination in the error search.

47. The apparatus as claimed in claim 40, wherein the apparatus caused to determine values for the difference parameters in the error search is further caused to:
select a difference parameter, wherein the difference parameter has an associated defined initial value and value range;
generate a camera rectification dependent on the initial value of the difference parameter;
generate a value of the error criterion dependent on the camera rectification and at least one matched feature;
repeat selecting a further difference parameter value, generating a camera rectification and generating a value of the error criterion until a smallest value of the error criterion is found for the difference parameter; and
repeat selecting a further difference parameter until all of the at least two difference parameters have determined values for the difference parameters which minimise the error search.

48. The apparatus as claimed in claim 40, wherein the apparatus is further caused to:
generate a first image of the at least two images with a first camera; and
generate a second image of the at least two images with a second camera.

49. The apparatus as claimed in claim 40, wherein the apparatus is further caused to:
generate a first image of the at least two images with a first camera at a first position; and
generate a second image of the at least two images with the first camera at a second position displaced from the first position.

50. The apparatus as claimed in claim 40, wherein the error criterion comprises at least one of:
a Sampson distance metric;
a symmetric epipolar distance metric;
a vertical feature shift metric;
a left-to-right consistency metric;
a mutual area metric; and
a projective distortion metric.

51. The apparatus as claimed in claim 40, wherein the difference parameter comprises at least one of:
a rotation shift;
a Rotation Shift Pitch;
a Rotation Shift Roll;
a Rotation Shift Yaw;
a translational shift;
a translational shift on the Vertical (Y) Axis;
a translation shift on the Depth (Z) Axis;
a horizontal focal length difference;
a vertical focal length difference;
an optical distortion in the optical system;
a difference in zoom factor;
a non-rigid affine distortion;
a Horizontal Axis (X) Shear;
a Vertical Axis (Y) Shear; and
a Depth (Z) Axis Shear.

52. A computer program product comprising a non-transitory computer readable medium having program code portions stored thereon, the program code portions configured upon execution to:
analyse at least two images to determine at least one matched feature;
determine at least two difference parameters between the at least two images; and
determine values for the at least two difference parameters in an error search using an error criterion based on the at least one matched feature in the at least two images and an estimated difference parameter value, wherein the value for each difference parameter is determined serially.
